(19) United States
(12) Patent Application Publication
(10) Pub. No.: US 2026/0092559 A1
(43) Pub. Date: Apr. 2, 2026

(54) AIRCRAFT ENGINE OIL JET WITH INDUCED SWIRLING

(71) Applicant: PRATT & WHITNEY CANADA CORP., Longueuil (CA)

(72) Inventor: Pawel Rak, Rzeszów (PL)

(21) Appl. No.: 18/893,353

(22) Filed: Sep. 23, 2024

(51) Int. Cl. F02C 7/06; B33Y 10/00; F16N 7/38

(52) U.S. Cl. CPC F02C 7/06; B33Y 10/00; F05D 2220/323; F05D 2260/14; F05D 2260/98; F16N 7/38; F16N 2210/02

(57) ABSTRACT

An aircraft engine includes a part requiring lubrication and a lubrication system operable to lubricate the part. The lubrication system includes a pump connected to deliver lubricant to a lubricant injection jet. The lubricant injection jet includes a first upstream portion with a first cross-sectional area bore communicating into a jet cone having a jet cross-sectional area that is smaller than the first cross-sectional area bore of the first upstream portion. The jet cone is operable to deliver lubricant to the part. Structure within the first upstream portion is structured to induce swirling into the lubricant, with the structure ending before the jet cone. A gas turbine engine and a method are also disclosed.

### FIELD OF TECHNOLOGY

This application relates to an oil jet injector for aircraft engines that has structure upstream of the jet to induce swirling into the oil moving into the jet.

### BACKGROUND

Many modern systems require lubrication for moving parts and cooling of moving and static parts. As one example, a gas turbine engine has a plurality of moving parts that require lubrication. Gears are typically lubricated and cooled, as one example, while housings (especially in hot zones) are typically cooled, either by air or oil, etc.

The oil jet injectors typically include a first cross-section diameter portion and then a jet. The transition between the large portion leading into the jet can raise cavitation concerns.

### SUMMARY

An aircraft engine includes a part requiring lubrication and a lubrication system operable to lubricate the part. The lubrication system includes a pump connected to deliver lubricant to a lubricant injection jet. The lubricant injection jet includes a first upstream portion with a first cross-sectional area bore communicating into a jet cone having a jet cross-sectional area that is smaller than the first cross-sectional area bore of the first upstream portion. The jet cone is operable to deliver lubricant to the part. Structure within the first upstream portion is structured to induce swirling into the lubricant, with the structure ending before the jet cone.

A gas turbine engine includes a compressor section, a turbine section, a combustor section and at least one rotating shaft. A mechanical system includes a part requiring lubrication and a lubrication system operable to lubricate the part. The lubrication system includes a pump connected to deliver lubricant to a lubricant injection jet. The lubricant injection jet includes a first upstream portion with a first cross-sectional area bore communicating into a jet cone having a jet cross-sectional area that is smaller than the first cross-sectional area bore of the first upstream portion. The jet cone is operable to deliver lubricant to the part. Structure within the first upstream portion is structured to include swirling into the lubricant, with the structure ending before the jet cone.

A method of forming a lubricant injection jet includes the steps of utilizing additive manufacturing to form a lubricant injection jet body having a first upstream portion with a first cross-sectional area bore and communicating into a downstream jet cone having a jet cross-sectional area that is smaller than the first cross-sectional area bore of the first upstream portion. Additive manufacturing is utilized to form a swirl inducing structure into the first upstream portion and not in the jet cone.

These and other features will be best understood from the following drawings and specification, the following is a brief description.

### BRIEF DESCRIPTION OF THE DRAWINGS

FIG. 1 schematically shows a gas turbine engine.

FIG. 2 shows a lubrication system for a gear set that may be in the FIG. 1 engine to accessories.

FIG. 3 is a detail of a lubricant jet.

FIG. 4 shows an alternative embodiment lubricant jet.

FIG. 5 schematically shows a method of forming embodiments of this disclosure.

### DETAILED DESCRIPTION

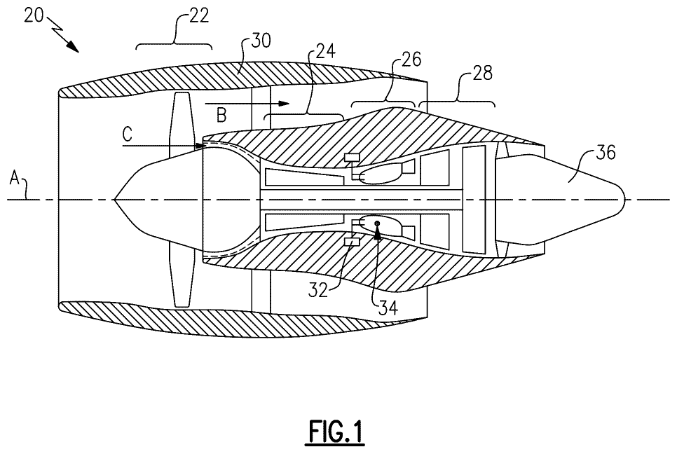

FIG. 1 schematically illustrates a gas turbine engine 20. The example gas turbine engine 20 is a turbofan that generally incorporates a fan section 22, a compressor section 24, a combustor section 26 and a turbine section 28. The fan section 22 drives air along a bypass flow path B in a bypass duct defined within a nacelle 30. The turbine engine 20 intakes air along a core flow path C into the compressor section 24 for compression and communication into the combustor section 26. In the combustor section 26, the compressed air is mixed with fuel from a fuel system 32, driven by a gear-set (extracting energy from high pressure turbine shaft) and ignited by igniter 34 to generate an exhaust gas flow that expands through the turbine section 28 and is exhausted through exhaust nozzle 36. Although depicted as a turbofan turbine engine in the disclosed non-limiting embodiment, it should be understood that the concepts described herein are not limited to use with turbofans as the teachings may be applied to other types of turbine engines. As one example, rather than having the propulsor be an enclosed fan, the propulsor may be an open propeller. This embodiment can also be applied to industrial gas turbine engine as well.

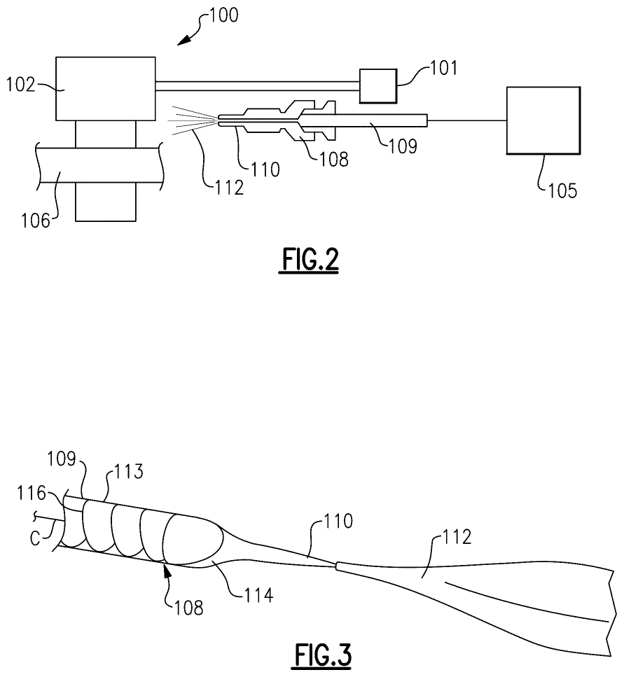

FIG. 2 shows a gear set 100 including a gears 102 mounted on a rotating shafts 106. The gear set 100 may drive a fuel pump 102, but may drive many other accessories.

As shown, an oil or lubricant injection jet 108 has a reduced diameter jet cone 110 spraying lubricant 112 into or out of the gears 102.

A pump 105 supplies pressurized lubricant into the oil injection jet 108.

In the prior art, the oil injection jet 108 includes a first cross-section bore portion 109 approaching the jet cone 110, wherein the cross-sectional area is reduced relative to the first cross-section bore.

In the prior art there were low pressure zones at edges of the entrance into the jet cone. This can result in cavitation related damage.

As shown in FIG. 3, there is the reduced diameter jet cone 110, but also an enlarged cross-sectional portion 109 within a wall 113 upstream of the jet 110. Both portion 109 and jet 110 are centered on the centerline C.

The oil injection jet 108 includes spiral structure 116 extending across an interior of the enlarged portion 109, but ending at a transition point 114 to the reduced cross-sectional jet 110.

There are a plurality of helical turns within the spiral structure 116.

The spiral structure 116 induces swirling into the oil moving into the jet 110. This moves cavitation zone away from the walls, addressing cavitation challenges mentioned above.

In addition, the oil 112 leaving the jet cone 110 will spread due to centrifugal force. This allows the oil jet injector 108 to provide lubricant to a greater surface area on the gears 102, as shown in FIG. 2, or other features requiring spread/area cooling (also static ones, like housings).

FIG. 4 shows an alternative embodiment 120. Here the enlarged cross-sectional portion is formed by an outer wall 122 having nominal smaller diameter portions 124, and rifling or grooves extending along a spiral 126/128/130. As shown, there are a plurality of such grooves 126/128 and 130.

The rifling also induce swirling into the oil as it moves into the jet cone 110, providing the benefits as mentioned above.

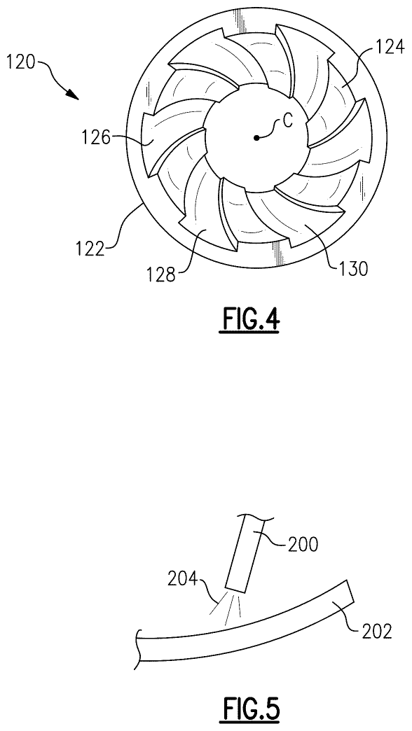

FIG. 5 schematically shows the formation of the structure disclosed herein. An additive manufacturing machine 200 is depositing additive manufacturing material 204 to form an intermediate lubricant injection jet 202. To form the complex structures to provide the swirl inducement, additive manufacturing will be a valuable method.

However, forming the structure in the jet would be challenging. Thus, ending the swirl inducing structure before the jet cone provides benefits.

An aircraft engine under this disclosure could be said to include a part requiring lubrication and a lubrication system operable to lubricate the part. The lubrication system includes a pump connected to deliver lubricant to a lubricant injection jet. The lubricant injection jet includes a first upstream portion with a first cross-sectional area bore communicating into a jet cone having a jet cross-sectional area that is smaller than the first cross-sectional area bore of the first upstream portion. The jet cone is operable to deliver lubricant to the part. Structure within the first upstream portion is structured to induce swirling into the lubricant, with the structure ending before the jet cone.

In another embodiment according to the previous embodiment, the structure includes a spiral member extending along the cross-sectional area bore of the first upstream portion.

In another embodiment according to any of the previous embodiments, there are a plurality of helical turns within the spiral member.

In another embodiment according to any of the previous embodiments, the structure is rifled grooves formed in an inner periphery of a bore within a wall forming the first upstream portion.

In another embodiment according to any of the previous embodiments, the part is a rotating part.

In another embodiment according to any of the previous embodiments, the rotating part is a portion of a gear set.

A gas turbine engine under this disclosure could be said to include a compressor section, a turbine section, a combustor section and at least one rotating shaft. A mechanical system includes a part requiring lubrication and a lubrication system operable to lubricate the part. The lubrication system includes a pump connected to deliver lubricant to a lubricant injection jet. The lubricant injection jet includes a first upstream portion with a first cross-sectional area bore communicating into a jet cone having a jet cross-sectional area that is smaller than the cross-sectional area bore of the first upstream portion. The jet cone is operable to deliver lubricant to the part. Structure within the first upstream portion is structured to induce swirling into the lubricant, with the structure ending before the jet cone.

In another embodiment according to any of the previous embodiments, the structure includes a spiral member extending along the cross-sectional area bore of the first upstream portion.

In another embodiment according to any of the previous embodiments, there are a plurality of helical turns within the spiral member.

In another embodiment according to any of the previous embodiments, the structure is rifled grooves formed in an inner periphery of a bore within a wall forming the upstream portion.

In another embodiment according to any of the previous embodiments, the part is a rotating part.

In another embodiment according to any of the previous embodiments, the rotating part is a portion of a gear set.

In another embodiment according to any of the previous embodiments, the structure includes a spiral member extending along the cross-sectional area bore of the first upstream portion.

In another embodiment according to any of the previous embodiments, the structure is rifled grooves formed in an inner periphery of a bore within a wall forming the upstream portion.

A method of forming a lubricant injection jet under this disclosure could be said to include the steps of utilizing additive manufacturing to form a lubricant injection jet body having a first upstream portion with a first cross-sectional area bore and communicating into a downstream jet cone having a jet cross-sectional area that is smaller than the first cross-sectional area bore of the first upstream portion. Additive manufacturing is utilized to form a swirl inducing structure into the first upstream portion and not in the jet cone.

In another embodiment according to any of the previous embodiments, the swirl inducing structure includes a spiral member is formed to extend along a bore of the first upstream portion.

In another embodiment according to any of the previous embodiments, the swirl inducing structure is rifled grooves formed in an inner periphery of a bore within a wall forming the first upstream portion.

In another embodiment according to any of the previous embodiments, the lubricant injection jet is then mounted to deliver oil to a part.

In another embodiment according to any of the previous embodiments, the part is a gear associated with a gas turbine engine.

In another embodiment according to any of the previous embodiments, the gear drives an accessory.

Although embodiments have been disclosed, a worker of skill in this art would recognize that modifications would come within the scope of this disclosure. For that reason, the following claims should be studied to determine the true scope and content.

What is claimed is:

1. An aircraft engine comprising:
a part requiring lubrication;
a lubrication system operable to lubricate the part;
the lubrication system including a pump connected to deliver lubricant to a lubricant injection jet;
the lubricant injection jet including a first upstream portion with a first cross-sectional area bore communicating into a jet cone having a jet cross-sectional area that is smaller than the first cross-sectional area bore of the first upstream portion, the jet cone being operable to deliver lubricant to the part; and
structure within the first upstream portion structured to induce swirling into the lubricant, with the structure ending before the jet cone.

2. The system as set forth in claim 1, wherein the structure includes a spiral member extending along the cross-sectional area bore of the first upstream portion.

3. The system as set forth in claim 2, wherein there are a plurality of helical turns within the spiral member.

4. The system as set forth in claim 1, wherein the structure is rifled grooves formed in an inner periphery of a bore within a wall forming the first upstream portion.

5. The system as set forth in claim 1, wherein the part is a rotating part.

6. The system as set forth in claim 5, wherein the rotating part is a portion of a gear set.

7. A gas turbine engine comprising:
a compressor section;
a turbine section;
a combustor section; and
at least one rotating shaft;
a mechanical system comprising:
a part requiring lubrication;
a lubrication system operable to lubricate the part;
the lubrication system including a pump connected to deliver lubricant to a lubricant injection jet;
the lubricant injection jet including a first upstream portion with a first cross-sectional area bore communicating into a jet cone having a jet cross-sectional area that is smaller than the first cross-sectional area bore of the first upstream portion, the jet cone being operable to deliver lubricant to the part; and
structure within the first upstream portion structured to induce swirling into the lubricant, with the structure ending before the jet cone.

8. The gas turbine engine as set forth in claim 7, wherein the structure includes a spiral member extending along the cross-sectional area bore of the first upstream portion.

9. The gas turbine engine as set forth in claim 8, wherein there are a plurality of helical turns within the spiral member.

10. The gas turbine engine as set forth in claim 7, wherein the structure is rifled grooves formed in an inner periphery of a bore within a wall forming the upstream portion.

11. The gas turbine engine as set forth in claim 7, wherein the part is a rotating part.

12. The gas turbine engine as set forth in claim 11, wherein the rotating part is a portion of a gear set.

13. The gas turbine engine as set forth in claim 11, wherein the structure includes a spiral member extending along the cross-sectional area bore of the first upstream portion.

14. The gas turbine engine as set forth in claim 11, wherein the structure is rifled grooves formed in an inner periphery of a bore within a wall forming the upstream portion.

15. A method of forming a lubricant injection jet comprising the steps of:
utilizing additive manufacturing to form a lubricant injection jet body having a first upstream portion with a first cross-sectional area bore and communicating into a downstream jet cone having a jet cross-sectional area that is smaller than the first cross-sectional area bore of the first upstream portion; and
utilizing additive manufacturing to form a swirl inducing structure into the first upstream portion and not in the jet cone.

16. The method as set forth in claim 15, wherein the swirl inducing structure includes a spiral member is formed to extend along a bore of the first upstream portion.

17. The method as set forth in claim 15, wherein the swirl inducing structure is rifled grooves formed in an inner periphery of a bore within a wall forming the first upstream portion.

18. The method as set forth in claim 15, wherein the lubricant injection jet is then mounted to deliver oil to a part.

19. The method as set forth in claim 18, wherein the part is a gear associated with a gas turbine engine.

20. The method as set forth in claim 19, wherein the gear drives an accessory.
